(19) United States
(12) Patent Application Publication
(10) Pub. No.: US 2026/0305829 A1
(43) Pub. Date: Oct. 8, 2026

(54) Footrest Positioning and Adjustment Mechanism for Chairs

(71) Applicant: HSIN CHERNQ ENTERPRISE CO., LTD., Taichung City (TW)

(72) Inventor: Mao-Chien Chao, Taichung City (TW)

(21) Appl. No.: 19/203,448

(22) Filed: May 9, 2025

(30) Foreign Application Priority Data
Apr. 2, 2025 (TW) 114112767

(51) Int. Cl. A47C 7/50; A47C 7/00; F16B 12/10

(52) U.S. Cl. CPC A47C 7/5064; A47C 7/004; F16B 12/10

(57) ABSTRACT

A footrest positioning and adjustment mechanism for chairs includes: a central tube includes an accommodating space and an inner annular surface, the inner annular surface faces the accommodating space and has a protrusion; and a sleeve body is disposed in the accommodating space and includes a slit and an outer peripheral surface facing the inner annular surface, the outer peripheral surface includes a positioning groove, the protrusion is disposed in the positioning groove, the positioning groove extends along a circumferential direction of the sleeve body and has a loose-fitting portion and an opposite tight-fitting portion along the circumferential direction, the thickness of the tight-fitting portion is greater than that of the loose-fitting portion, so that when the protrusion is in the tight-fitting portion, the total thickness is greater than that when in the loose-fitting portion, generating a compressive tightening effect toward the center of the sleeve body.

### BACKGROUND

### Field of the Invention

The present invention relates to an assembly mechanism for chair footrest, and more particularly to a footrest positioning and adjustment mechanism for chairs.

### Description of Related Art

Referring to FIG. 1, the traditional bar chair footrest ring lifting mechanism adopts a single-point fixing design. Its structure includes a main shaft 81, a footrest ring 82, a C-shaped sleeve 83 and a screw 84. The footrest ring 82 is provided with a central tube 821 at the center thereof, along with a screw hole 822 located in the middle section of the central tube 821.

The screw 84 fixes the vertical position of the footrest ring 82 through the screw hole 822. When the screw 84 is tightened, the C-shaped sleeve 83 will be pressed against the main shaft 81. This design not only requires strenuous operation but also has the following problems:

The C-shaped sleeve 83 is made of plastic, which is originally used to enhance the stress between the screw 84 and the main shaft 81. However, under long-term use, the pressure from the screw 84 will damage the surface of the C-shaped sleeve 83, causing it to lose its function.

The concentrated pressure caused by the single-point fixing will deform the main shaft 81, reducing the performance of the entire mechanism.

The vertical position of the footrest ring 82 is fixed only by a single screw 84. When the user steps on the footrest ring 82, the weight will cause the footrest ring 82 to tilt and the main shaft 81 to deform.

In summary, the single-point fixing design not only causes damage to the C-shaped sleeve 83 and deformation of the main shaft 81, but also makes the footrest ring 82 prone to tilting, posing a safety hazard to users.

### SUMMARY

The present invention provides a footrest positioning and adjustment mechanism for chairs, the main objective of which is to offer an adjustment mechanism capable of quickly adjusting the footrest ring while ensuring stability and steadiness.

To achieve the above objective, a footrest positioning and adjustment mechanism for chairs, provided by the invention comprises:

a central tube defines an accommodating space and includes an inner annular surface, the inner annular surface faces the accommodating space and has at least one protrusion; and

a sleeve body is disposed in the accommodating space and includes at least one slit, wherein the sleeve body includes an outer peripheral surface facing the inner annular surface of the central tube, the outer peripheral surface has at least one positioning groove, the protrusion is disposed in the positioning groove, the positioning groove extends along a circumferential direction of the sleeve body and has a loose-fitting portion and an opposite tight-fitting portion along the circumferential direction, a depth of the positioning groove is defined as a groove depth, and the groove depth of the tight-fitting portion is shallower than that of the loose-fitting portion.

As can be seen from the above, the present invention mainly features that the sleeve body has at least one positioning groove on the outer peripheral surface, and the positioning groove has opposite loose-fitting portions and tight-fitting portions along the circumferential direction, with the groove depth of the tight-fitting portion being shallower than that of the loose-fitting portion. Additionally, the protrusion is located in the positioning groove, so that when the user rotates the central tube, the protrusion can move along the circumferential direction within the positioning groove. When the protrusion is located at the tight-fitting portion, the total thickness is greater than when the protrusion is located at the loose-fitting portion. This configuration creates a compressed and tightly secured state toward the center of the sleeve body when the protrusion is in the tight-fitting portion, or maintains a loose-fitting state when positioned at the loose-fitting portion. The sleeve body can rapidly rotate along the circumferential length of the positioning groove to switch between non-tight and tight states, which achieves an adjustment mechanism that enables quick footrest ring adjustment while maintaining both stability and secure positioning.

### BRIEF DESCRIPTION OF THE DRAWINGS

FIG. 1 is an exploded view of a conventional footrest positioning and adjustment mechanism for chairs applied to a footrest ring and a main shaft;

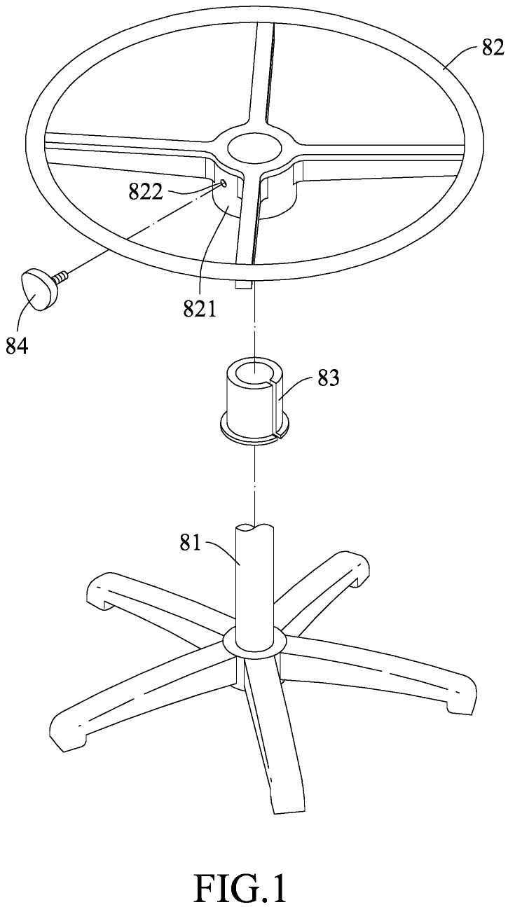

FIG. 2 is an exploded view of the footrest positioning and adjustment mechanism for chairs of the present invention;

FIG. 3 is a three-dimensional view of the footrest positioning and adjustment mechanism for chairs of the present invention;

FIG. 4 is a cross-sectional view in the non-tight state;

FIG. 5 is a cross-sectional view in the tight state;

FIG. 6A is a three-dimensional view of one embodiment of the sleeve body;

FIG. 6B is a cross-sectional view of one embodiment of the sleeve body;

FIG. 7A is a three-dimensional view of another embodiment of the sleeve body;

FIG. 7B is a cross-sectional view of another embodiment of the sleeve body;

FIG. 8A is a three-dimensional view of yet another embodiment of the sleeve body;

FIG. 8B is a cross-sectional view of yet another embodiment of the sleeve body;

FIG. 9 is a cross-sectional view of a preferred embodiment of the sleeve body;

FIG. 10 is a cross-sectional view of a preferred embodiment of the sleeve body;

FIG. 11 is a cross-sectional view of a preferred embodiment of the sleeve body;

FIG. 12 is a cross-sectional view of a preferred embodiment of the sleeve body matched with the central tube; and

FIG. 13 is a cross-sectional view of another preferred embodiment of the sleeve body matched with the central tube.

### DETAILED DESCRIPTION

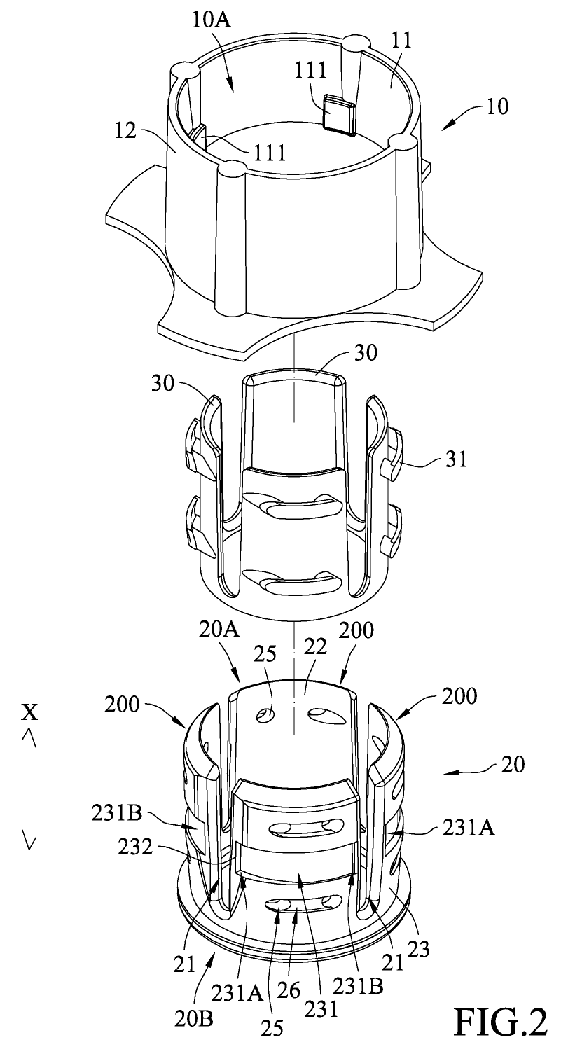

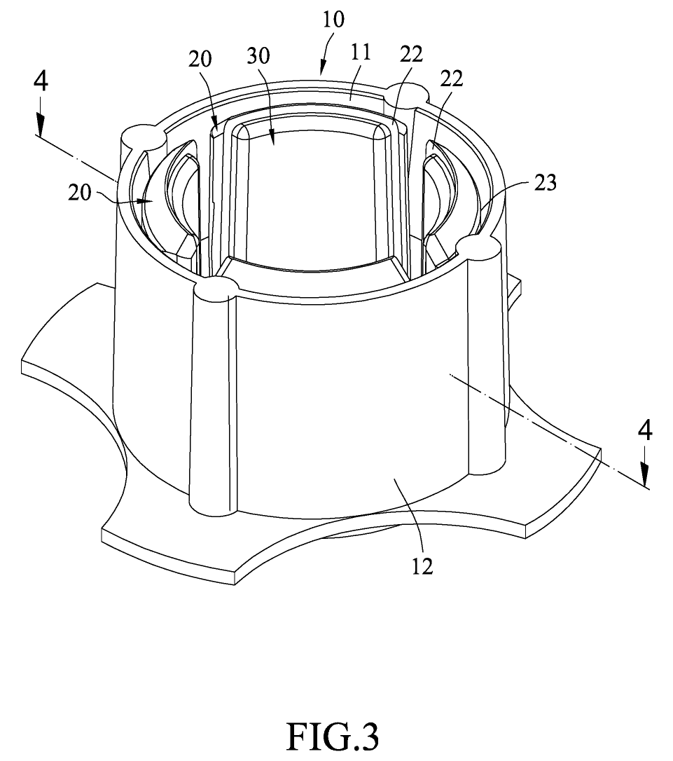

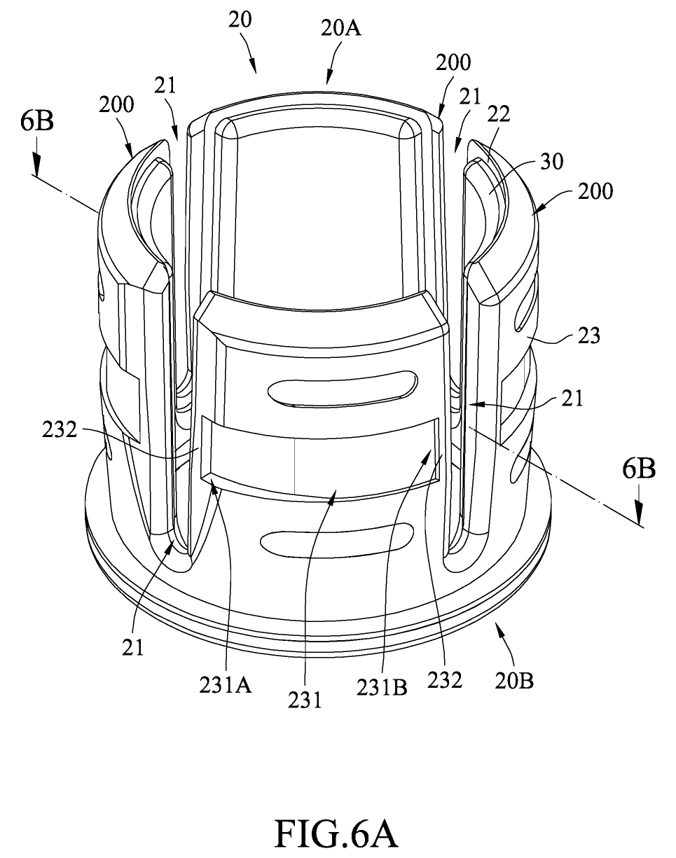

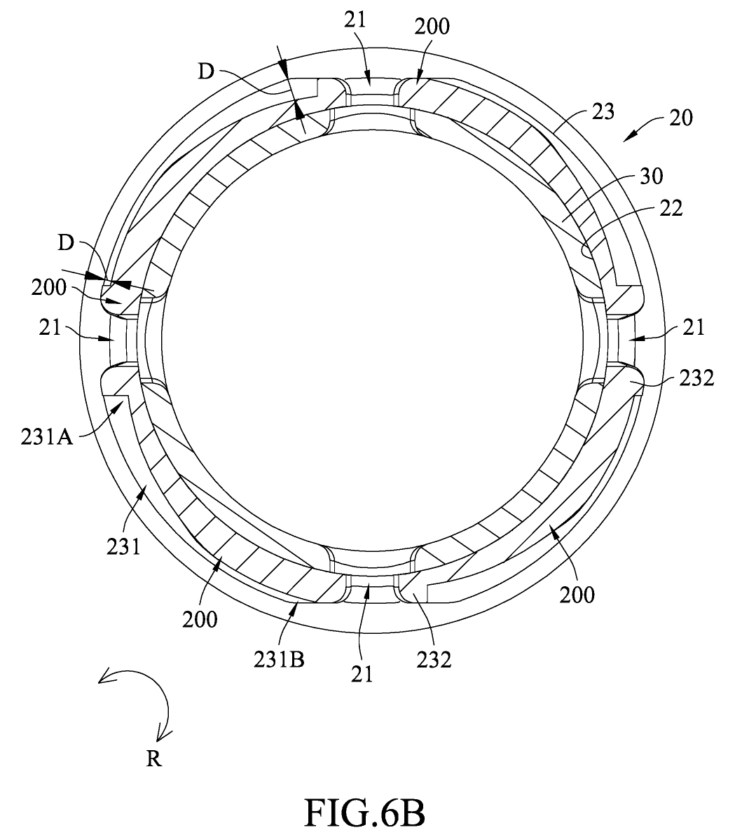

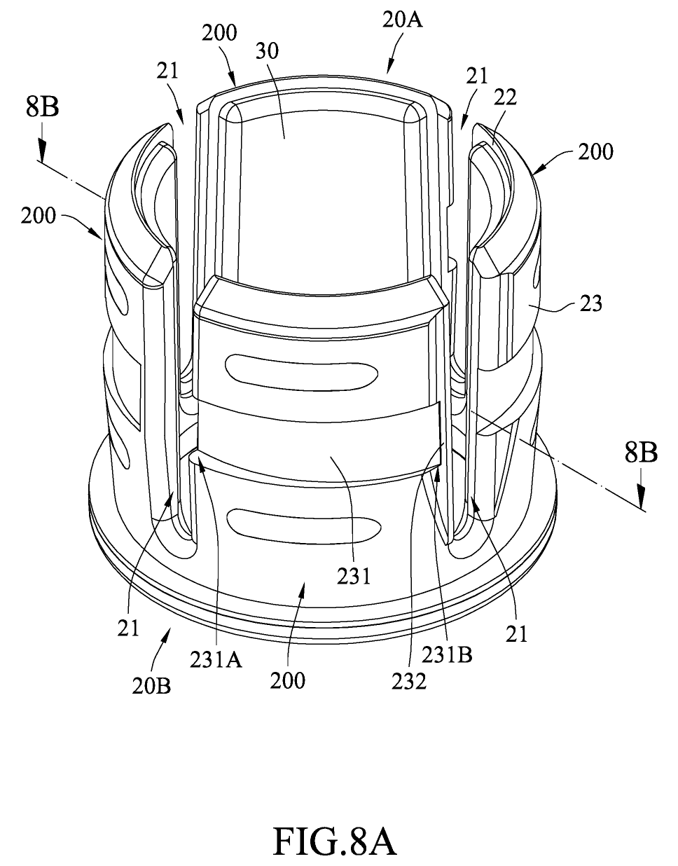

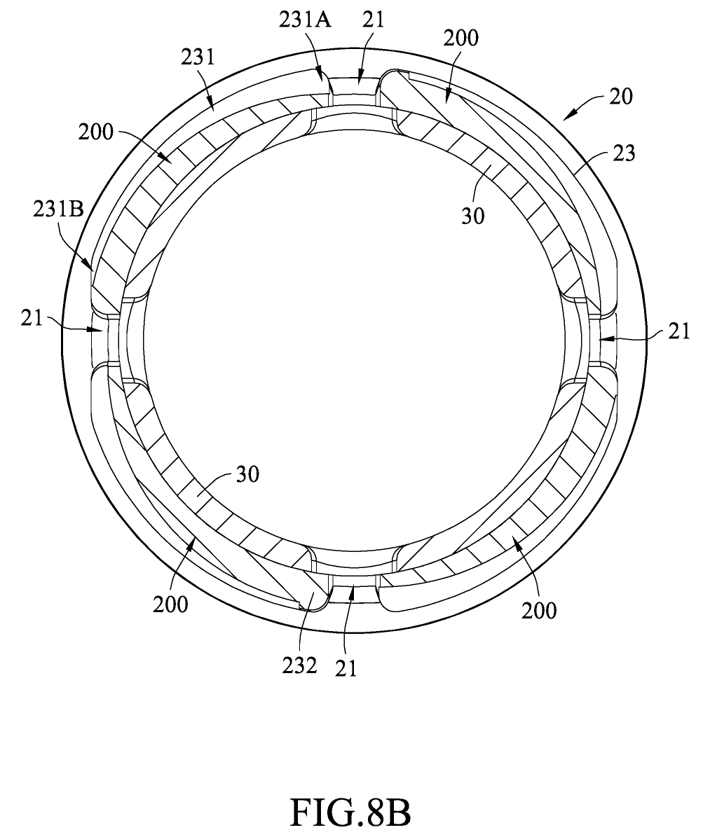

The present invention provides a footrest positioning and adjustment mechanism for chairs. As shown in FIGS. 2-11, the mechanism includes:

A central tube 10, generally in a hollow cylindrical shape, where the central tube 10 forms an accommodating space 10A. The central tube 10 has an inner annular surface 11 and outer annular surface 12 opposite to each other. The inner annular surface 11 faces the accommodating space 10A and has at least one protrusion 111. The central tube 10 can be part of the footrest ring.

A sleeve body 20, generally in a hollow cylindrical shape, is configured to sleeve on a main shaft A of the chair. The sleeve body 20 defines an axial direction X extending along the cylindrical axis thereof, a radial direction Y perpendicular to and passing through the axial direction X, and a circumferential direction R extending along a peripheral surface thereof. The sleeve body 20 is arranged in the accommodating space 10A and has a first end 20A and an opposite second end 20B along the axial direction X. The sleeve body 20 has at least one slit 21 extending along the axial direction X. The slit 21 penetrates the first end 20A and extends to a position close to the second end 20B without penetrating the second end 20B, which allows the slit 21 to provide space for the sleeve body 20 to contract inward when the sleeve body 20 is compressed along the radial direction Y, enabling the sleeve body 20 to shrink inward.

The sleeve body 20 has an inner peripheral surface 22 and an opposite outer peripheral surface 23 along the radial direction Y. The inner peripheral surface 22 faces the main shaft A, and the outer peripheral surface 23 faces the inner annular surface 11 of the central tube 10, with a certain thickness between the inner peripheral surface 22 and the outer peripheral surface 23. The outer peripheral surface 23 has at least one positioning groove 231, in which the protrusion 111 is located. The positioning groove 231 extends along the circumferential direction R of the sleeve body 20 and has a loose-fitting portion 231A and an opposite tight-fitting portion 231B along the circumferential direction R. The depth of the positioning groove 231 along the radial direction Y is defined as a groove depth D. The groove depth D of the tight-fitting portion 231B is shallower than that of the loose-fitting portion 231A, meaning the thickness from the tight-fitting portion 231B to the inner peripheral surface 22 is greater than that from the loose-fitting portion 231A to the inner peripheral surface 22. The groove depth D gradually increases from the tight-fitting portion 231B to the loose-fitting portion 231A, and other forms such as steps or other inclined surface configurations are also possible, without being limited thereto.

In a preferred embodiment, the sleeve body 20 further includes a buffer portion 30 on the inner peripheral surface 22. The buffer portion 30 is made of a material softer than that of the sleeve body 20 and is configured to abut against the main shaft A of the chair, which facilitates the displacement of the sleeve body 20 along the main shaft A and avoids damage to the main shaft A or the sleeve body 20. The buffer portion 30 can be separately molded and then elastically assembled into a one-piece structure with the sleeve body 20 or can be integrally formed with the sleeve body 20 by secondary injection molding, or even directly co-molded in one piece with the sleeve body 20 by double injection molding.

In this embodiment, as shown in FIGS. 2-6B, the number of slits 21 is four. These slits 21 are equidistantly distributed along the circumferential direction R on the sleeve body 20, forming four compression portions 200 on the sleeve body 20. There is one slit 21 between each pair of compression portions 200, and the outer peripheral surface 23 of each compression portion 200 has one positioning groove 231. The loose-fitting portion 231A of each positioning groove 231 is adjacent to the tight-fitting portion 231B of an adjacent positioning groove 231.

The number of protrusions 111 on the central tube 10 is four. These protrusions 111 are equidistantly distributed on the inner annular surface 11, and each of the protrusions 111 is located in the positioning groove 231 of a corresponding one of the compression portions 200.

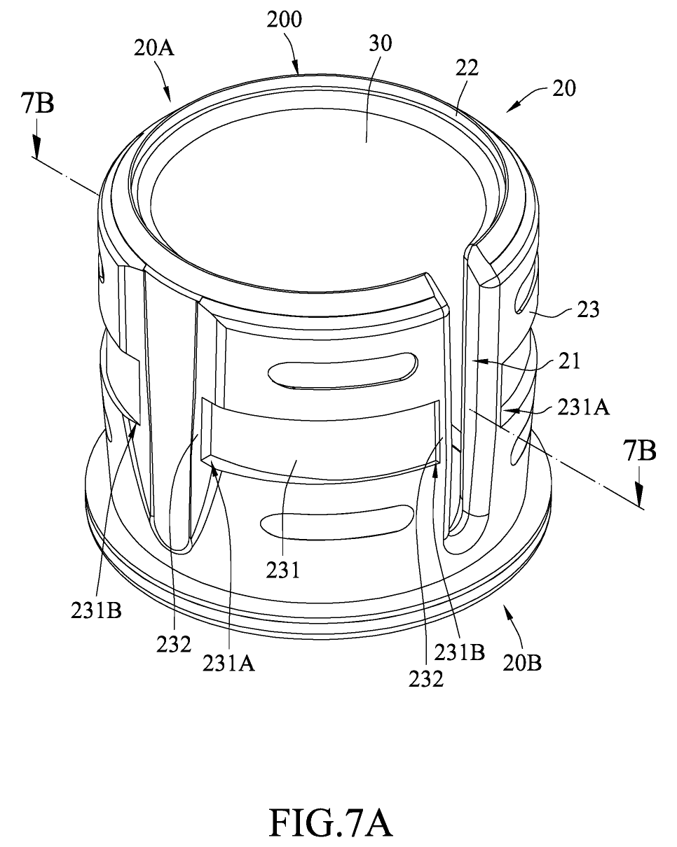

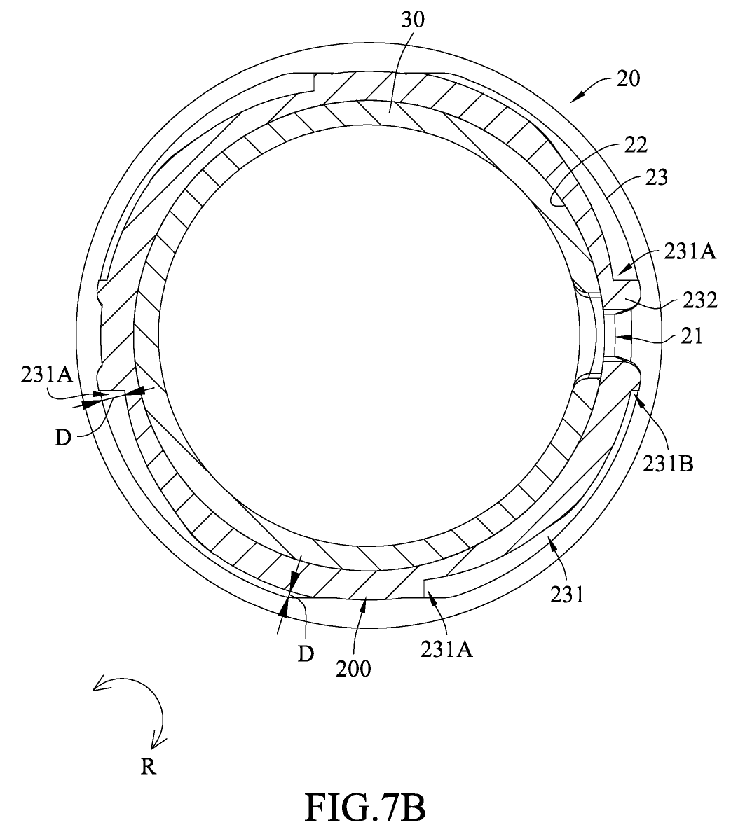

In other embodiments, as shown in FIGS. 7A-7B, there is only one slit 21, and the sleeve body 20 has one compression portion 200, which is an annular structure with an opening.

In other embodiments, the number of slits 21 is two, causing the sleeve body 20 to form two compression portions 200. The two compression portions 200 are spaced by one slit 21 at one end thereof along the circumferential direction R and by another slit 21 at the other end along the circumferential direction R.

However, it is not limited thereto, and the number of slits 21 can also be three, five, six, etc.

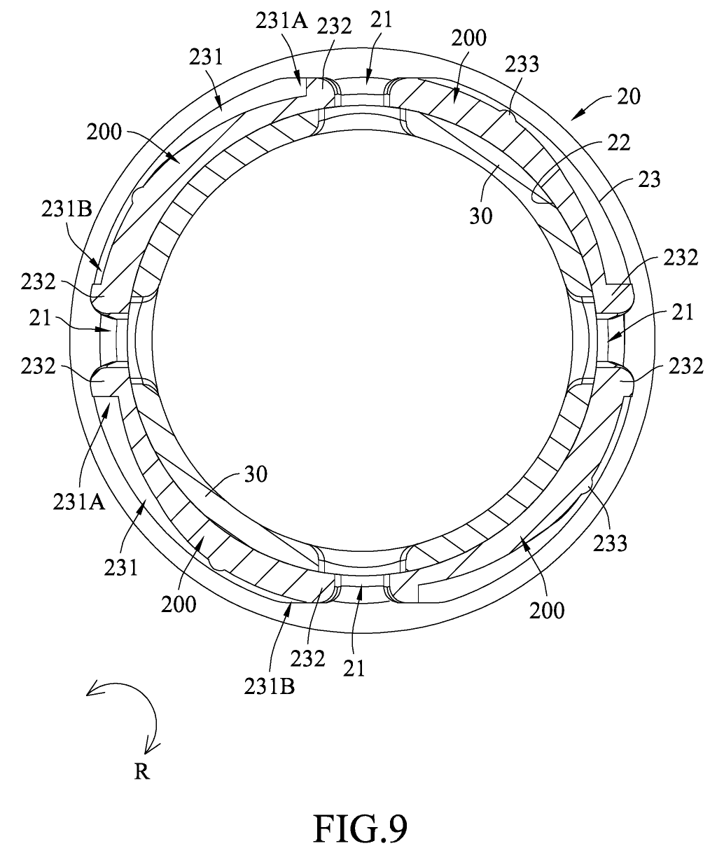

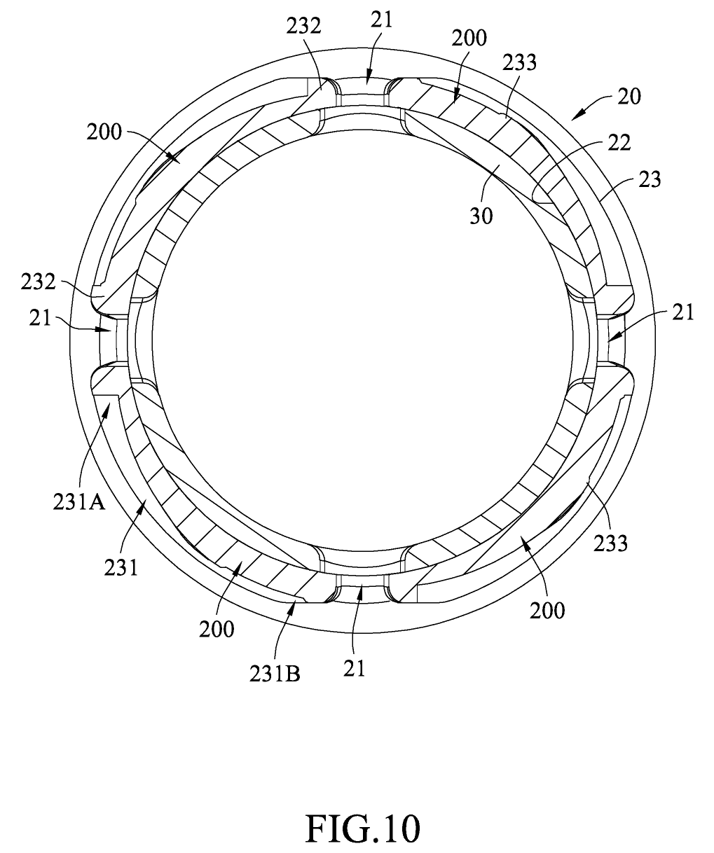

In a preferred embodiment, as shown in FIGS. 9 and 10, the outer peripheral surface 23 of the sleeve body 20 has a protruding portion 233 located in the positioning groove 231 and positioned between the loose-fitting portion 231A and the tight-fitting portion 231B. The protruding portion 233 is configured to provide tactile feedback for the user.

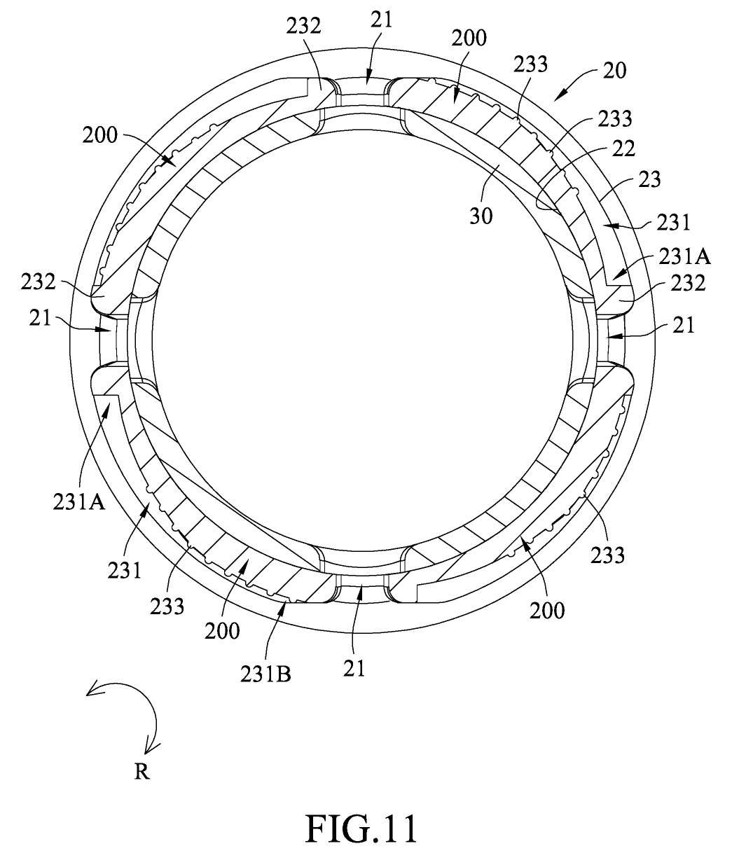

In a preferred embodiment, as shown in FIG. 11, the outer peripheral surface 23 of the sleeve body 20 includes a plurality of protruding portions 233 located in the positioning groove 231 and positioned between the loose-fitting portion 231A and the tight-fitting portion 231B.

In a preferred embodiment, as shown in FIG. 11, the sleeve body 20 further has a blocking protrusion 232 on the outer peripheral surface 23, located at one end of the positioning groove 231 along the circumferential direction R, at the end of the positioning groove 231 where the loose-fitting portion 231A is located, and specifically the blocking protrusion 232 is adjacent to the loose-fitting portion 231A. However, it is not limited thereto. As shown in FIG. 9, the blocking protrusion 232 can also be located at the end of the positioning groove 231 where the tight-fitting portion 231B is located and adjacent to the tight-fitting portion 231B. The blocking protrusion 232 is configured to limit the travel of the protrusion 111 to prevent the protrusion 111 from disengaging from the positioning groove 231.

In another embodiment, as shown in FIG. 9, the sleeve body 20 further includes two blocking protrusions 232 on the outer peripheral surface 23, respectively located on opposite ends of the positioning groove 231 along the circumferential direction R. One blocking protrusion 232 is at the end of the positioning groove 231 where the loose-fitting portion 231A is located and adjacent to the loose-fitting portion 231A, while the other blocking protrusion 232 is at the end of the positioning groove 231 where the tight-fitting portion 231B is located and adjacent to the tight-fitting portion 231B.

Preferably, as shown in FIG. 2, the sleeve body 20 further includes at least one through hole 25 penetrating the inner peripheral surface 22 and the outer peripheral surface 23. The buffer portion 30 is integrally connected with an attachment portion 31 located in the through hole 25, thereby enabling the buffer portion 30 to be more securely attached and combined with the inner peripheral surface 22 of the sleeve body 20.

Preferably, as shown in FIG. 2, the sleeve body 20 further includes at least one through hole 25 penetrating the inner peripheral surface 22 and the outer peripheral surface 23. The sleeve body 20 further includes an attachment groove 26 on the outer peripheral surface 23, which is connected to the through hole 25. The buffer portion 30 is integrally connected with an attachment portion 31 located in the through hole 25 and the attachment groove 26.

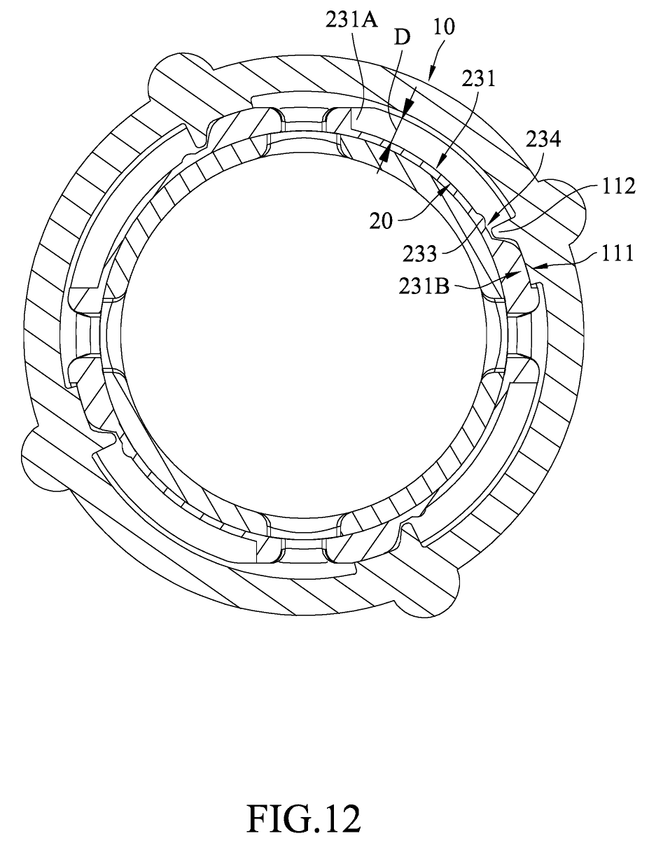

In another embodiment, as shown in FIG. 12, the groove depth D in this embodiment transitions stepwise from the tight-fitting portion 231B to the loose-fitting portion 231A. There is one protruding portion 233, and a limiting portion 234 is formed between the protruding portion 233 and the tight-fitting portion 231B. The inner annular surface 11 of the central tube 10 further includes a limiting protrusion 112 protruding at a position corresponding to the limiting portion 234. In this embodiment, the limiting protrusion 112 is disposed adjacent to the protrusion 111. When the protrusion 111 is in the tight position, the limiting protrusion 112 passes over the protruding portion 233 and is restricted within the limiting portion 234, ensuring secure engagement and tight positioning, so that different tightness requirements can be achieved in different limiting portions 234.

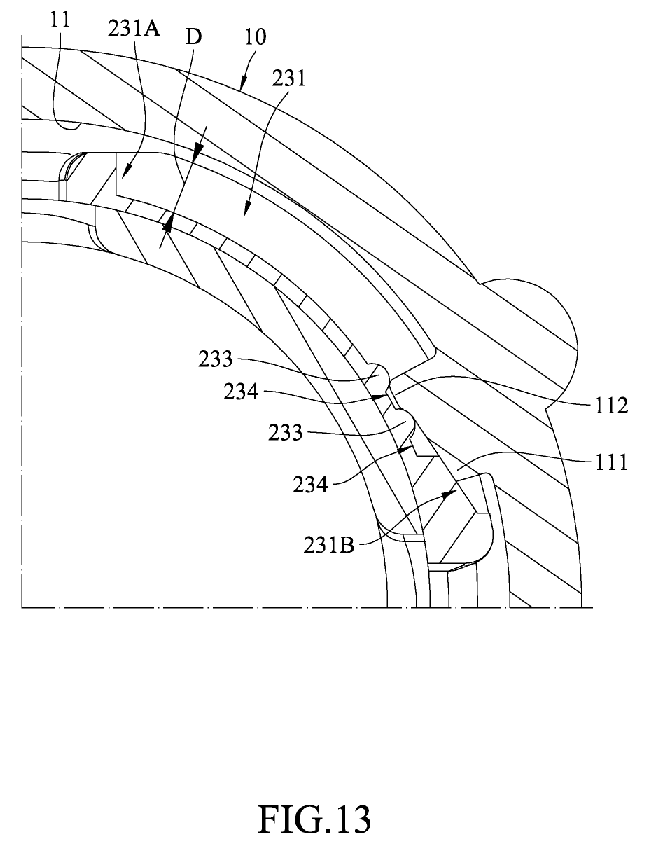

In another embodiment, as shown in FIG. 13, the groove depth D of the tight-fitting portion 231B is shallower than that of the loose-fitting portion 231A, that is, the thickness from the tight-fitting portion 231B to the inner peripheral surface 22 is greater than that from the loose-fitting portion 231A to the inner peripheral surface 22. However, in this embodiment, the groove depth D transitions stepwise from the tight-fitting portion 231B to the loose-fitting portion 231A, and there are two protruding portions 233. Between the two protruding portions 233 and between one of the two protruding portions 233 and the adjacent tight-fitting portion 231B, there is a distance each forming a limiting portion 234. The inner annular surface 11 of the central tube 10 further includes a limiting protrusion 112 protruding at a position corresponding to the limiting portion 234. In this embodiment, the limiting protrusion 112 is disposed adjacent to the protrusion 111, and the protrusion 111 features an inclined surface matching an inclined surface of the tight-fitting portion 231B. The thickness of the protrusion 111 varies from thick to thin gradually starting from the area adjacent to the limiting protrusion 112. The inclination of the inclined surface of the protrusion 111 can be the same as or different from that of the tight-fitting portion 231B. When the protrusion 111 is in the tight position, the protrusion 111 overlaps the tight-fitting portion 231B, and the limiting protrusion 112 passes over the protruding portion 233 and is restricted within the limiting portion 234, maintaining the locking to ensure tight positioning, and different tightness requirements can be achieved in different limiting portions 234.

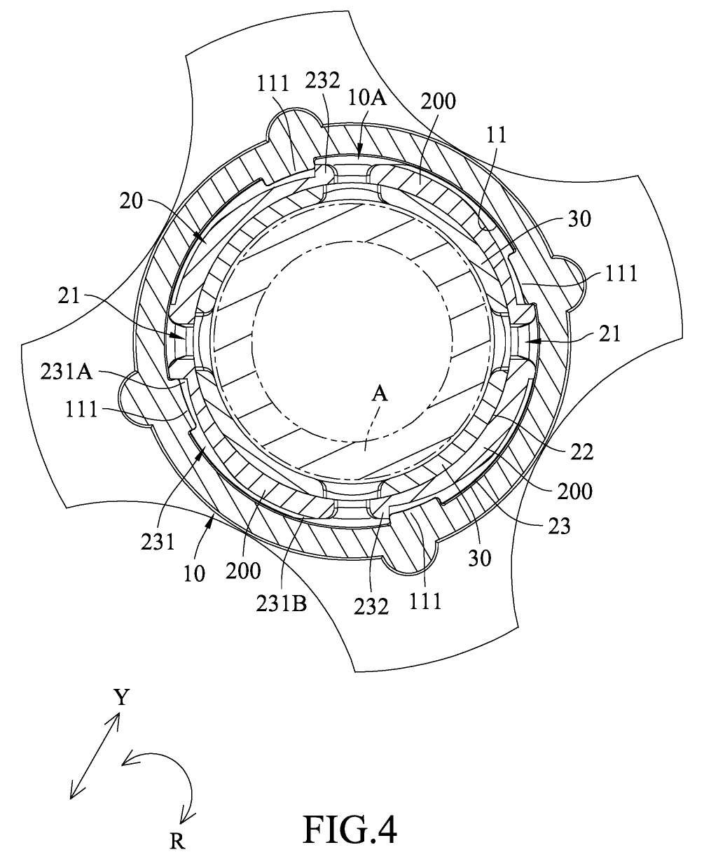

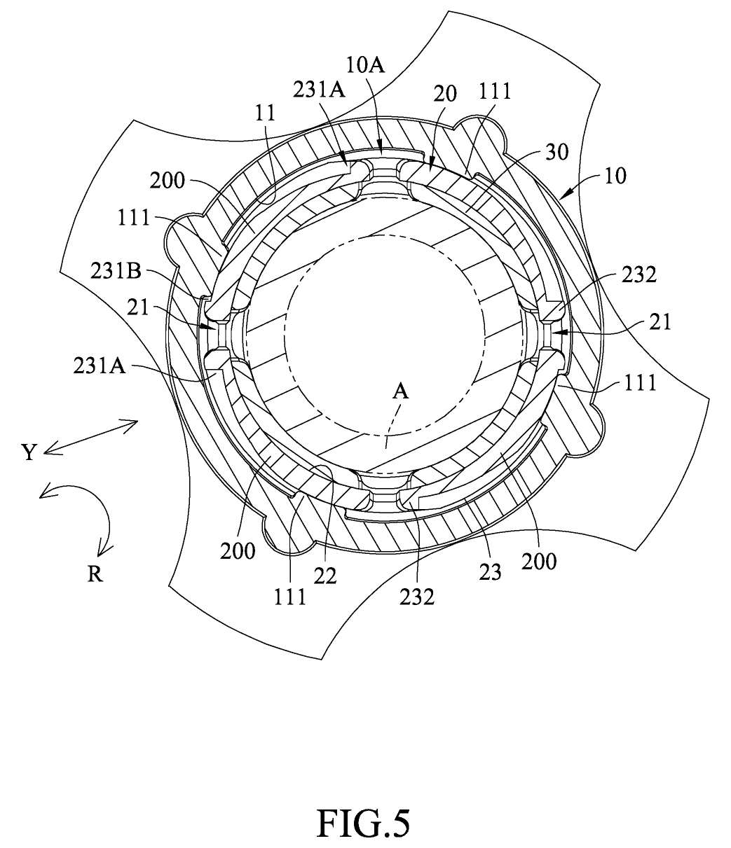

As can be seen from the above, the present invention mainly features that the sleeve body 20 has at least one positioning groove 231 on the outer peripheral surface 23, and the positioning groove 231 has opposite loose-fitting portions 231A and tight-fitting portions 231B along the circumferential direction R, with the groove depth D of the tight-fitting portion 231B being shallower than that of the loose-fitting portion 231A. Additionally, the protrusion 111 is located in the positioning groove 231, so that when the user rotates the central tube 10, the protrusion 111 can move along the circumferential direction R within the positioning groove 231. As shown in FIG. 4, when the protrusion 111 is in the loose-fitting portion 231A of the positioning groove 231, the sleeve body 20 is in a non-tight state, allowing the sleeve body 20 to move relative to the main shaft A. As shown in FIG. 5, when the protrusion 111 is in the tight-fitting portion 231B of the positioning groove 231, the sleeve body 20 is in a tight state, clamping the main shaft A to achieve a positioning effect.

What is claimed is:

1. A footrest positioning and adjustment mechanism for chairs, comprising:
a central tube defining an accommodating space and including an inner annular surface, the inner annular surface facing the accommodating space and having at least one protrusion; and
a sleeve body disposed in the accommodating space and including at least one slit, wherein the sleeve body includes an outer peripheral surface facing the inner annular surface of the central tube, the outer peripheral surface has at least one positioning groove, the protrusion is disposed in the positioning groove, the positioning groove extends along a circumferential direction of the sleeve body and has a loose-fitting portion and an opposite tight-fitting portion along the circumferential direction, a depth of the positioning groove is defined as a groove depth, and the groove depth of the tight-fitting portion is shallower than that of the loose-fitting portion.

2. The footrest positioning and adjustment mechanism for chairs as claimed in claim 1, wherein the sleeve body defines an axial direction, the at least one slit extends along the axial direction, the sleeve body has a first end and an opposite second end along the axial direction, and the slit penetrates the first end.

3. The footrest positioning and adjustment mechanism for chairs as claimed in claim 1, wherein the groove depth gradually increases from the tight-fitting portion to the loose-fitting portion.

4. The footrest positioning and adjustment mechanism for chairs as claimed in claim 1, wherein the groove depth transitions stepwise from the tight-fitting portion to the loose-fitting portion.

5. The footrest positioning and adjustment mechanism for chairs as claimed in claim 1, wherein the sleeve body includes an inner peripheral surface opposite to the outer peripheral surface, the sleeve body further includes a buffer portion on the inner peripheral surface, and the buffer portion is made of a material softer than that of the sleeve body.

6. The footrest positioning and adjustment mechanism for chairs as claimed in claim 1, wherein there are four said slits, the slits are spaced and distributed along the circumferential direction on the sleeve body, forming four compression portions on the sleeve body, there is one said slit between each pair of the compression portions, the outer peripheral surface of each of the compression portions has one positioning groove, the central tube includes four said protrusions, and each of the protrusions is located in the positioning groove of a corresponding one of the compression portions.

7. The footrest positioning and adjustment mechanism for chairs as claimed in claim 1, wherein there are said slits, the sleeve body includes two said compression portions, and the two compression portions are spaced by one slit at one end thereof and by another slit at another end thereof.

8. The footrest positioning and adjustment mechanism for chairs as claimed in claim 1, wherein the outer peripheral surface of the sleeve body includes a protruding portion located in the positioning groove and positioned between the loose-fitting portion and the tight-fitting portion.

9. The footrest positioning and adjustment mechanism for chairs as claimed in claim 8, wherein the sleeve body includes an inner peripheral surface opposite to the outer peripheral surface, the groove depth of the tight-fitting portion is shallower than that of the loose-fitting portion, the thickness from the tight-fitting portion to the inner peripheral surface is greater than that from the loose-fitting portion to the inner peripheral surface, a limiting portion is formed between the protruding portion and the tight-fitting portion, the inner annular surface of the central tube includes a limiting protrusion protruding at a position corresponding to the limiting portion, the limiting protrusion is disposed adjacent to the protrusion, when the protrusion is in a tight position, the protrusion overlaps the tight-fitting portion, and the limiting protrusion passes over the protruding portion and is restricted within the limiting portion.

10. The footrest positioning and adjustment mechanism for chairs as claimed in claim 9, wherein there are at least two said protruding portions, between the two protruding portions and between one of the two protruding portions and the adjacent tight-fitting portion, there is a distance each forming a limiting portion, the inner annular surface of the central tube includes the limiting protrusion protruding at a position corresponding to the limiting portion, the protrusions each has an inclined surface matching an inclined surface of the tight-fitting portion, a thickness of the protrusion varies from thick to thin gradually starting from the area adjacent to the limiting protrusion, an inclination of the inclined surface of the protrusion is the same as or different from that of the tight-fitting portion, when the protrusion is in the tight position, the protrusion overlaps the tight-fitting portion, and the limiting protrusion passes over the protruding portion and is restricted within the limiting portion.

11. The footrest positioning and adjustment mechanism for chairs as claimed in claim 1, wherein the sleeve body includes a blocking protrusion on the outer peripheral surface, and the blocking protrusion is located at one end of the positioning groove along the circumferential direction.
